(19) United States
(12) Patent Application Publication
(10) Pub. No.: US 2004/0120549 A1
(43) Pub. Date: Jun. 24, 2004

(54) Half-plane predictive cancellation method for laser radar distance image noise

(75) Inventors: Kwo-Jyr Wong, Taipei (TW); Kuo-Shu Chang, Taipei (TW)

Correspondence Address: JOHNSON & ASSOCIATES PC, 14625 BALTIMORE AVENUE #282, LAUREL, MD, 20707, US

(73) Assignee: Chung-Shan Institute of Science and Technology

(21) Appl. No.: 10/327,097

(22) Filed: Dec. 24, 2002

(51) Int. Cl. G06K 9/00; G06K 9/40

(52) U.S. Cl. 382/106; 382/275

(57) ABSTRACT

Half-plane predictive cancellation method for laser radar distance image noise employed in the present invention can perform real-time adjustment while conducting simultaneous pixel generation and noise cancellation during the scanning process. The same method can also be used in performing line-by-line operation after completion of each line scan. The latter half-plane of the line-by-line scanning operation can shift from left-to-right or right-to-left or reverse scanning direction after the completion of each line scan to decrease the possibilities of error accumulation.

### BACKGROUND OF THE INVENTION

The half-plane predictive cancellation method for laser radar distance image noise of this invention is used for the real-time cancellation of laser radar noise to effectively improve distance image quality and is suitable for image noise processing for aerial photography. First of all, laser radar adopts the “dot, line, surface” method for image composition. Laser radar transceiver transmits single-pulses of laser beams to perform scanning operation in a dot-by-dot matter. The dots are then collected into lines and lines are collected into surfaces to generate the required image. This is different from the “single exposure, dot-by-dot collection” image processing method employed by the traditional cameras. Any solutions must fulfill the criteria of “real time completion” based on the mission requirements. This restraint results in the prior art masking method failure to satisfy the system requirement for laser radar imaging as the laser radar can not predict the possible location and the distance of the next laser beam.

Referring to FIG. 1, as shown is a prior art 3×3 masking method used in laser radar pixel scanning. In FIG. 1, using the 3×3 mid value filter as an example, assume the laser radar scanning direction is from left to right with moving direction from the bottom up, the 9 pixels are numbered serially from 1 to 9, and the scanning operation retrieve values of the 9 pixels in sequence. The prior art mid value method will retrieve the middle value among the sequence of the nominal pixel values and use it to replace the pixel value for number 5 (assume number 5 is a noise). During the laser radar scanning process of FIG. 1, when the number 5 pixel was justified as a noise, the value of numbers 6, 7, 8 and 9 is still unknown, as they have not been acquired yet. Thus the prior art 3×3 masking method is not suitable for the real-time acquisition of the laser radar image pixels.

Laser radar distance image had been used on the ATR (Automatic Target Recognition) of ground vehicles, but the HLV (Height-Limited Verticality) image processing method used for distance image is incompatible with the nature of the laser radar scanning process. Currently, no similar laser radar thesis regarding the real-time processing of noises created during the distance image generation process in single shot laser beam transmission/receiving had been released. Thus, a method for the real time cancellation of noises generated during the laser radar scanning process is required.

### SUMMARY OF THE INVENTION

It is an object of this invention is to use a half-plane predictive cancellation method for real-time cancellation of laser radar noise to effectively improve distance image quality.

Another object of this invention is to use the half-plane predictive cancellation method to perform line-by-line operation after completion of each line scan and to use the line-by-line operation to shift from left to right or right to left or to reverse scanning direction after the completion of each line scan to decrease the possibilities of error accumulation.

Still another object of this invention is to use the half-plane predictive cancellation method for real-time acquisition of the laser radar image pixels.

The present invention will be readily apparent upon reading the following description of a preferred exemplified embodiment of the invention and upon reference to the accompanying drawings.

### BRIEF DESCRIPTION OF DRAWINGS

FIG. 1 illustrates laser radar pixel scan using the prior art 3×3 masking method.

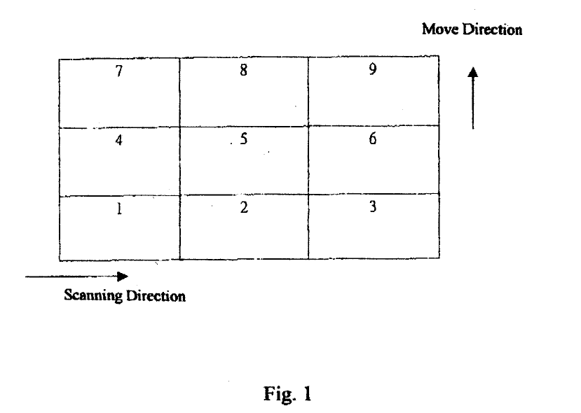

FIG. 2. illustrates relationships between the laser radar scan carrier to the ground; the effective scanning angle of each side (120°) of the scanning mirror (prism) is within the 2θ angle of the mirror center.

FIG. 3. illustrates the direction of line scans and the direction of carrier movements during laser radar scanning operations of the present invention.

FIG. 4. illustrates the comparison of three image pictures taken by laser radar imaging method of the present invention.

FIG. 5. illustrates a cross sectional profile of a mountainous terrain distance image using laser radar imaging method of the present invention.

### DETAILED DESCRIPTION OF THE INVENTION AND PREFERRED EMBODIMENTS

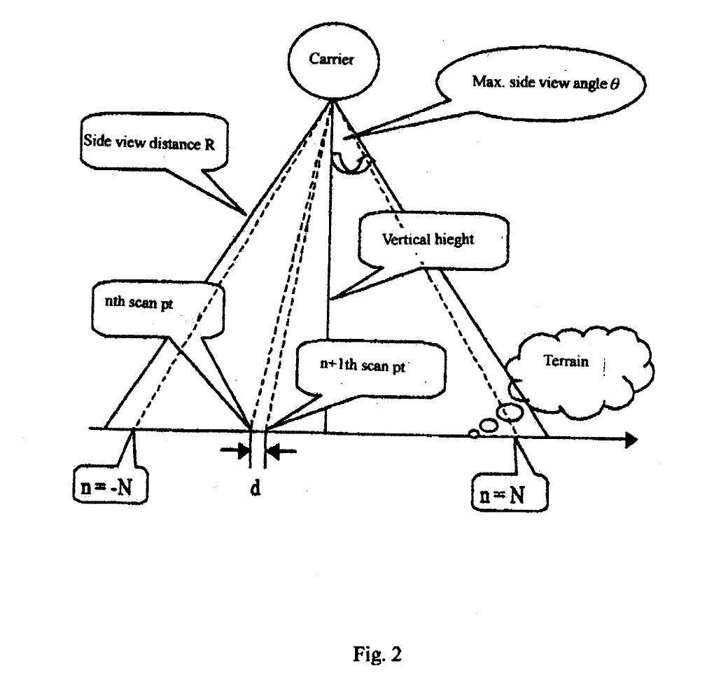

First, we describe the actual laser radar imaging operation referring to the relationship between the laser radar scan carrier and the ground as described in FIG. 2 where the effective scanning angle of each side (120°) of the scanning mirror (prism) is within the 2θ angle of the mirror center. Driven by motors, the prism generates three scanning image lines at the completion of a full circle. Based on the system image resolution requirement, the laser radar decides whether to generate one output image line per single interleave or multiple interleave scan image lines. A two-dimensional image is latter generated using the relative velocity movement between the airborne carrier and the vertical direction of the scan line.

The formation of the laser radar distance image noise is mainly due to factors such as the prolong distance between the airborne carrier and the ground or the low reflectivity of the target (such as paved road) causing a low S/N ratio in the reflection signal which can not be verified by the detection circuit on the receiver. Since the acquiring of distance data for each laser radar image dot relies on the transmission and reception of a single laser pulse, which is different from the obtaining effective average distance value through filtering of multiple To transmissions method employed by generic distance meters, the formation of noise on the laser radar distance image is inevitable. Due to hardware restraints, the only solution is through software image processing to reduce the noise's influence on mission capability to the minimum.

Under “real-time processing” system mission requirement and limited usable resources, several factors must be summarized and simplified to deduce a simple but effective equation to eliminate noise. To eliminate noise, we must first define what is noise? Further operations are possible only after we can verify the noise. FIG. 2 shows the relationship between the airborne carrier and the ground when the laser radar is performing scan image line processing under the assumption that the earth is a surface (this is not a reasonable assumption, especially when applied to rugged terrains). From FIG. 2, the reasonable value of the two-dimensional distance image is between the vertical height H and the maximum side-view distance R, which are both explained by the following relationship:

R=H/ cos θ (1)

In other words, the deviation of the two-dimensional distance image within a short range should be limited. This is under the assumption that the earth is a surface, which is not valid. Even so, if we can expand the possible deviation to an acceptable value to tolerate the variation of the terrain altitude and the deviation is separable from the noise value, we can design a noise cancellation method under such condition.

We will describe the method used in the present invention based on the reasonable deviation range of the distance value. Prior to the execution of laser radar mapping mission, the image resolution (as depicted in FIG. 2) requirement must be sought. With fixed sample number (2N) for each lens, the laser radar calculates the timing for the transmittal of each sampling pulse (2N number of transmission timings composed a transmission table) based on the flying altitude.

Using the following equation

θn=tan (n×d÷2H) (2)

We can determine if the transmittal angle On of each laser beam exceeds θ (possible when H is too low or d is too large) θ will be used instead of θn. For example, if θ=40°, from equation (1), the maximum effective side-view distance R is around 1.155H, and the maximum deviation between R and H can reach as much as 0.155H. When H is higher than 650 meters, the tolerable distance deviation between R and H can reach over 100 meters. Considering the heights of the power towers and most of the buildings, the variation of the actual elevation in the terrain and the visual characteristics of the human eyes, we set X meter as the upper limit, Y (Y=X+3r) meter as the lower limit for the allowable deviation range of the distance error and r is the distance resolution. The lower limit exceeds the upper limit by 3r meter in the deviation range; the main consideration is the lack of sensitivity of the human eyes when viewing dimmer areas on gray scale images. When the measured distance exceeds this “reasonable” deviation range, it will be considered as a “noise”.

We will then describe the calculation required in verifying if the noise is within the reference distance value under the reasonable deviation range. As a principle, prior to the execution of laser radar mapping, a little preparation time must be reserve for the build-up of the transmission table and the adjustment of the motor speed. In this time period, we can calculate the average value of a small distance section and use that average value as the reference value of the reasonable deviation range. After the completion of each line scan, this reference value will be used to generate a new reference value by weighted processing the average value of the new lines with the existing reference value using recursive filter method.

The noise cancellation method must provide two types of information: First, what is the reasonable distance reference value and what is the range? Any distance value exceeding this range will be considered as “noise” and must be replaced with a “reasonable value”. Second, how do we find this “reasonable value”? For those pixels verified as noise, calculate a reasonable value to replace the distance value of the noise pixel using “half-plane predictive method”.

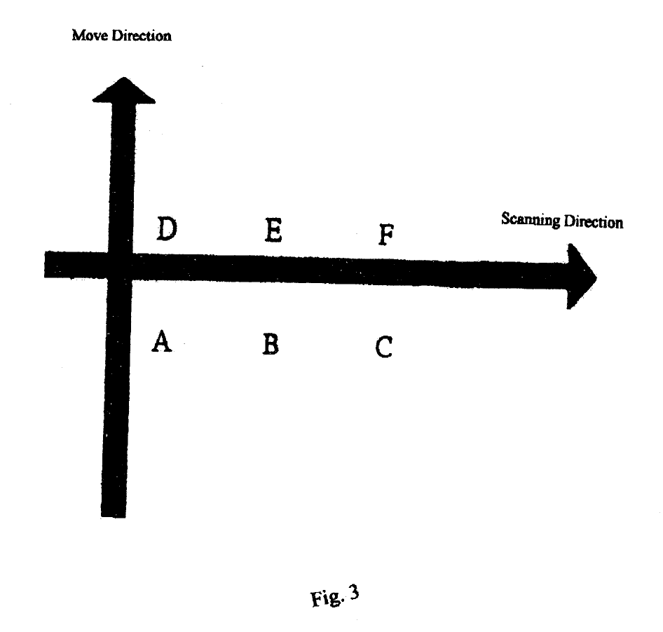

FIG. 3 shows the line scanning direction and the airborne carrier moving direction of the laser radar mapping operation. If E point is the noise and A, B and D is the know effective distance data then we can use equation (3) to calculate a reasonable value for E using these three adjacent points. This calculation constitutes the main technical reasoning behind the “half-plane predictive method” described in the present invention, which is to calculate a reasonable value using equation (3) to replace the E noise point. This approach is convenient for computer processing and since C is a known effective value we can also calculate the value of E using equation (4).

Reason for using this method is that the “divide by 4” operation in C programming language is equal to left-shifting the sum for two bits. The required calculation is fewer than what is required to perform a “divide by 3” floating-point operation. Thus we can also use equation (4) to calculate a reasonable value to replace E noise point for ease of computer operations.

E═Function (A, B, D)=(A+B+D)/3 (3)

E=Function (A, B, C, D)−(A+B+C+D)/4 (4)

Additionally, the method described in FIG. 3 eliminates the noise and perform real-time adjustment during the scanning process while the pixels are generated. Using the same method, we can also perform the same tasks on a line-by-line basis after the completion of each line scan. The half-plane of the latter can shift from left-to-right or right-to-left or reversing scanning direction after completion of each line scan to decrease the possibilities of error accumulation. When the half-plane predictive method is used in right-to-left movement use equation (4) E=(A+B+C+D)/4 to calculate the value of E. The calculation algorithm for the half-plane predictive cancellation method for laser radar distance image noise used in the present invention is explain as follows:

First, we define the parameters:

r is the distance resolution of the image;

up_bound=X/r is the upper maximum gray scale deviation of the reasonable distance;

low_bound=Y/r is the lower maximum gray scale deviation of the reasonable distance;

high=232 is the upper gray scale value of the effective distance;

low=6 is the lower gray scale value of the effective distance;

area_mean is the gray scale reference value of the reasonable distance;

area_up=area_mean+up_bound is the maximum reasonable gray scale value of the distance;

area_down=area mean_low_bound is the minimum gray scale value of the distance;

line mean is the average value of pixel gray scale per line;

valid_line_mean is the average value of pixel gray scale per line after noise cancellation

Since two-dimensional distance image uses 8-bits for display, the pixel gray scale range is from 0˜255. When performing image processing, the present invention transform the actual distance value and the possible deviation range value into pixel gray scale value for direct calculation. The numbers in the above definition are all in pixel gray scale values and actual distance is equal to the number times the image distance resolution r.

The calculation algorithm:

Step 1:

When the laser radar enter the mapping area to perform scanning operation, calculate the average value of the latest 20 distance data as the reasonable distance reference value (area_mean ). If any of the 20 distance data value (pixel gray scale value) is >high or <low do not include that value into the calculation of the average value.

Step 2:

Calculate the upper limit area up and lower limit area_down of the reasonable gray scale value. If area_up >high, then let area_up=high; if area_up<low, then let area_down=low.

Step 3:

Verified the pixel gray scale value of the prior 20 lines and the current scan to verify if there exist any >high or <low situation. If yes, replace with the reasonable pixel gray scale reference value (area_mean).

Step 4:

Apply left-to-right or right-to-left half-plane predictive method interchangeably to cancellation noises for each and every follow-up line.

Step 5:

If any of the pixel gray scale value is >high or <low, replace with area_mean.

Step 6:

If the pixel gray scale value is between area_up and area_down, treat such value as an effective value; otherwise treat it as a noise and use half-plane predictive method to calculate a reasonable value to replace it.

Step 7:

Repeat Step 5and Step 6 until the completion of a line scan.

Step 8:

Calculate the average value of the pixel gray scale of each line (line_mean) after Step 5; also calculate the average value of the average value of the effective pixel gray scale average value (valid_line_mean) after Step 6.

Step 9:

Refresh the gray scale reference value of the reasonable range area_mean=(12*area_mean+3*valid_line_mean+1*line_mean)/16 and recalculate.

Step 10: Repeat Step 4 to Step 9.

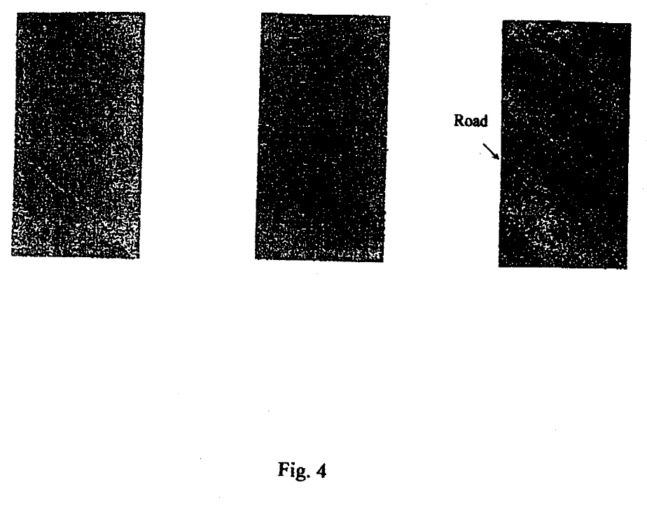

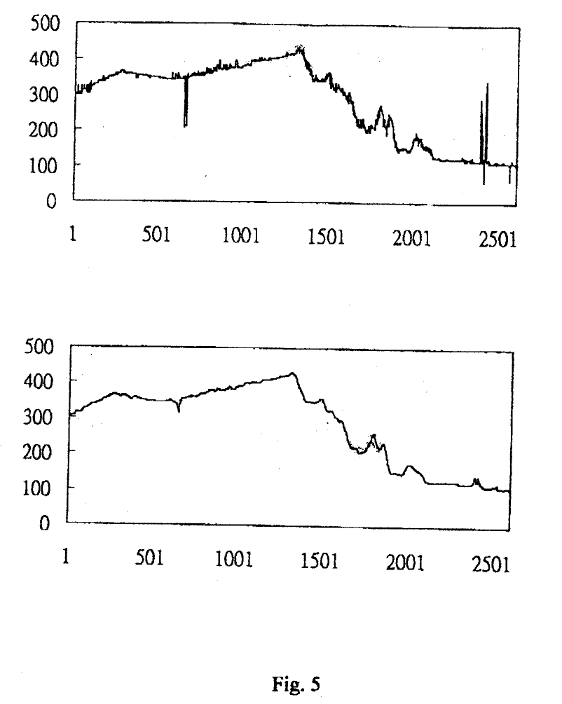

Other than special terrains, the elevation changes on most terrain is not that dramatic, the pixel value of any dot in a two-dimensional image is highly relational to the pixel value in adjacent area. Using the average value of the adjacent know distance value to replace the noise is a reasonable method and is the most cited feature in many image processing principles. In our invention, we use the average value of 20 filtered scanned line data as the reference value of the reasonable distance. With consideration on the visual characteristics of the human eyes and the actual geographical features, we set upper limit of X meters and lower limit of Y (=X+20) meters as the allowable error deviation range and perform noise cancellation using half-plane cancellation method. This technique not only eliminates the dotted noises, but also corrects the slice or belt type noises caused by clouds, roads or rivers, which proved to be a feasible solution. The innovation of the present invention based on actual implementation is further explained in FIGS. 4 and 5.

FIG. 4 shows three laser radar images for comparison used in the present invention. The invention selected a length with 2,500 lines of distance image (as shown in the left of the FIG. 4): the first ⅕ of the image contains vast numbers of noises; the middle area contains targets with poor reflectivity such as roads and rivers; the cloud overcast on almost the middle of the image (with two obvious horizontal lines); and the white dots in the figure are the noses, which are distinct relative to the adjacent areas.

FIG. 4 is the collection of the three types of images, with processed high altitude (distance) image in the middle, original high-altitude (distance) image on the left and the relative enhanced image on the right. From the result of the process, when the noise ratio is relatively low, this method can almost eliminate all the noises, the resulting image is smoother and accomplished the expected objective of the present invention.

FIG. 5 shows the cross section profile of a mountainous terrain laser radar distance image using methods described in the present invention. The upper figure is the original profile values. Great variation exists due to the existence of noise. The lower figure is the profile values after applying noise cancellation method described in the present invention. Clearly, the lines in the lower figure is smoother with lesser variations, which also accomplished the expected objective of the present invention. By all means, the half-plane predictive cancellation method for laser radar distance image noise proposed in the present invention can effectively improve the distance and image quality and when incorporated with enhance imaging can be used to built a complete 3D image.

Various additional modification of the embodiments specifically illustrated and described herein will be apparent to those skilled in the art in light of the teachings of the present invention. The invention should not be construed as limited to the specific form and examples as shown and described. The invention is set forth in the following claims.

What is claimed is:

1. A half-plane predictive cancellation method for laser radar distance image noise, wherein said method comprising the steps of:
Step 1:
When the laser radar enters the mapping area to perform imaging operation, calculate the average value of the latest N distance data as the reasonable distance reference value (area_mean). If any of the N distance data value (pixel gray scale value) is >high or <low, do not include that value into the calculation of the average value;
Step 2:
Calculate the upper limit area_up and lower limit area_down of the reasonable gray scale value. If area_up>high, then let area_up=high; if area_up<low, then let area_down_low;
Step 3:
Verified the pixel gray scale value of the prior N lines and the current scan to verify if exist any >high or <low situation. If yes, replace with the reasonable pixel gray scale reference value (area_mean);
Step 4:
Apply left-to-right or right-to-left half-plane predictive method interchangeably to cancellation noises for each and every follow-up line;
Step 5:
If any of the pixel gray scale value is >high or <low, replace with area_mean;
Step 6:
If the pixel gray scale value is between area_up and area_down, treat such value as an effective value; otherwise treat it as a noise and using half-plane-predictive method to calculate a reasonable value to replace it;
Step 7:
Repeat Step 5 and Step 6 until the completion of a line scan;
Step 8:
Calculate the average value of the pixel gray scale of each line (line mean) after Step 5; also calculate the average value of the average value of the effective pixel gray scale average value (valid_line_mean) after Step 6;
Step 9:
Refresh the gray scale reference value of the reasonable range area_mean=(12*area_mean□3*valid_line_mean□1*line_mean)/16 and recalculate; Step 10: Repeat Step 4 to Step 9;
Where:
r is the distance resolution of the image;
N is the number of lines scanned;
X is the upper limit of the reasonable distance;
Y is the lower limit of the reasonable distance;
Up_bound=X/r is the upper maximum gray scale deviation of the reasonable distance;
Low_bound=Y/r is the lower maximum gray scale deviation of the reasonable distance;
high=232 is the upper gray scale value of the effective distance;
low=6 is the lower gray scale value of the effective distance;
area_mean is the gray scale reference value of the reasonable distance;
area_up=area_mean+up_bound is the maximum reasonable gray scale value of the distance;
area_down=area mean+low_bound is the minimum gray scale value of the distance;
line_mean is the average value of pixel gray scale per line; and
valid_line_mean is the average value of pixel gray scale per line after noise cancellation.

2. The method as in claim 1, wherein Y=X+3r is the allowable range for distance errors.

3. The method as in claim 1, wherein N is equal or greater than 2.
